(19) United States
(12) Patent Application Publication
(10) Pub. No.: US 2002/0087337 A1
(43) Pub. Date: Jul. 4, 2002

(54) System to ensure customer privacy in an e-business

(76) Inventor: David W. Hensley, Dallas, TX (US)

Correspondence Address: Jonathan M. Harris, Conley, Rose & Tayon, P.C., P.O. Box 3267, Houston, TX, 77253-3267, US

(21) Appl. No.: 09/752,117

(22) Filed: Dec. 29, 2000

(51) Int. Cl. G06F 17/60

(52) U.S. Cl. 705/1; 705/74

(57) ABSTRACT

A business system includes at least one customer (and typically a plurality), at least one service provider (and typically a plurality, and a service broker. The broker maintains a customer database which includes a record for each customer. Each record includes customer information and an alias, generated by the broker, to identify the customer to the service providers. The service providers receive a reduced or redacted copy of the customer database that identifies the customers only by their aliases, thereby ensuring the privacy of the customer information.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to a method and apparatus for ensuring customer privacy in an on-line business. More particularly, the invention relates to ensuring customer privacy through the use of aliases in a business system that includes service providers and brokers.

2. Background of the Invention

On-line networks, such as today's Internet, have facilitated the dissemination of information between entities coupled to the network on a global basis. The Internet has made possible tremendous growth in transactions relating to manufacturers, wholesalers, retailers, consumers, and other business entities (producers and consumers) in the marketplace. For example, consumers can now purchase goods and services from retailers over the Internet without ever leaving their computer. The Internet has literally put tens of thousands of vendors within easy “virtual” reach of consumers.

The advent of any new technology is usually not free of problems. The on-line business arena is certainly no exception. In that area, at least three problems exist related to privacy of customer information: (1) maintaining the privacy of the businesses customer information assets; (2) dissemination of customer information to providers of goods and services without the customer's specific approval; and (3) providing regulatory proof that privacy has been preserved. Privacy of personal information is an issue that is gaining more and more attention, and may become subject to regulatory constraints. Furthermore, in at least some areas various providers of telecommunications, web and E-business services have fragmented into specialized providers of a single service (such as IP transport or cellular telephone service) or content (such as a reference library or catalog service). This fragmentation is beginning to cause some frustration among customers, who now must deal with many companies to obtain the same level of service, including billing and customer care, they once obtained from a single source.

An emerging solution to this fragmentation problem is the use of a “broker” (or “retailer”) of services to customers. This broker facilitates numerous service providers (or “wholesalers”) to provide their services to the customers of the broker. In this broker business model the customer again has a single source for all services and content, has a single financial arrangement, and has a single interface for problems and customer care. Unfortunately, the broker must still provide an extensive amount of information to each service provider so that the service providers may provide services and content to their customers. Currently, few businesses are implementing a broker model, and those that do simply send necessary customer information to each required wholesaler. As more businesses adopt the broker model and the number of wholesalers being used grows, the privacy problems will become more severe. Any legislation regarding the control and dissemination of customer information may exacerbate the problem. Another emerging issue is the desire of retailer/brokers to “own” the customer relationship. Dissemination of detailed customer information may provide a competitive advantage to wholesalers desiring to provide a retailer/broker service.

The broker model is an emerging business model, so the privacy issues are just now becoming apparent. However, businesses that adopt this model are sending the actual customer information to each wholesaler and are not ensuring the privacy of the customer information and not protecting the business assets (the customer relationship) of the retailer/broker. Also, operators of full-service networks (i.e., a single company that provides both the retailer function and all services) must currently send detailed customer information to many diverse network elements, each of which has different security mechanisms. This makes it extremely difficult to both ensure security and prove the information has been kept confidential.

Accordingly, a system is needed that permits a broker to function as an intermediary between customers and one or more wholesalers, while maintaining the privacy of the customer information and providing the wholesalers the information they need to provide their goods or services to the customer.

### BRIEF SUMMARY OF THE INVENTION

The problems noted above are solved in large part by a business system that includes at least one customer (and typically a plurality), at least one service provider (and typically a plurality, and a service broker. The broker provides a unified customer care interface to the customer, without the customer being aware of the involvement of multiple service providers. The broker maintains a customer database which includes a record for each customer. Each record includes customer information and an alias, generated by the broker, to identify the customer to the service providers. The service providers receive a reduced or redacted copy of the customer database that identifies the customers only by their aliases, thereby ensuring the privacy of the customer information.

These and other advantages will become apparent upon reviewing the following disclosure and drawings.

### BRIEF DESCRIPTION OF THE DRAWINGS

For a detailed description of the preferred embodiments of the invention, reference will now be made to the accompanying drawings in which:

FIG. 1 shows a system diagram of a broker-service provider business system using aliases in accordance with a preferred embodiment of the invention; and

FIG. 2 shows an alternative embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .”. Also, the term “couple” or “couples” is intended to mean either an indirect or direct electrical connection. Thus, if a first device couples to a second device, that connection may be through a direct electrical connection, or through an indirect electrical connection via other devices and connections.

The term “service provider” refers to a wholesaler of goods or services that are provided to customers. The term “broker” refers to a “middle person” that may or may not provide services to a customer and functions generally as the go-between between the customer and the service providers for purposes of billing and other types of transactions. The term “customer” refers to a purchaser and consumer of goods and services provided by the service provider. The term “services” is intended to refer to both goods and services

### DETAILED DESCRIPTION OF THE PREFERRED EMBODIMENTS

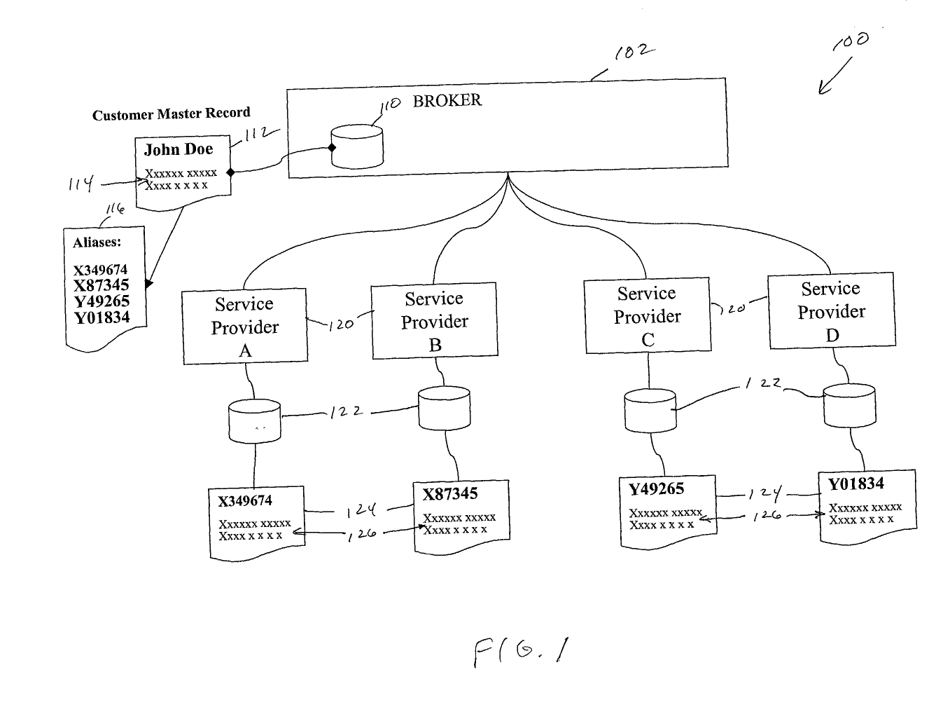

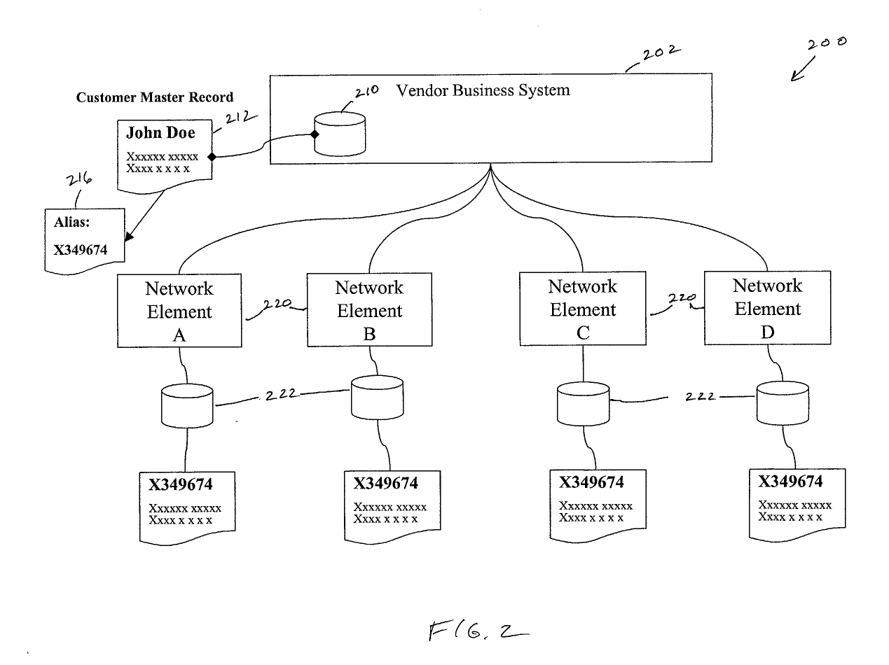

In accordance with a preferred embodiment of the invention, all customer information exists in a single secured facility controlled by the organization which handles the customer relationship. That organization (the “broker”) may either provide services to the customer itself, or may contract with service providers to provide the services to the customer. Generally, only the broker has an interface with the customers, thereby providing a unified customer care interface to the customer. One or more aliases is associated with each customer and preferably only the broker which handles the customer relationship can match the customers to their aliases. As customer information is disseminated to other entities, preferably the customer's alias is provided, and the customer name or other customer-identifying information (e.g., social security number) is not provided to the other entities. Alternatively, some specific items of customer-identifying information may be provided in conjunction with the alias. Numerous embodiments of this principle are possible, such as those shown in FIGS. 1 and 2 which are described below.

Referring now to FIG. 1, a business system 100 is shown in accordance with a preferred embodiment of the invention. As shown, the business system 100 includes a broker 102 and one or more service providers 120 (Service Providers A-D coupled together via a network such as the Internet). In general, the service providers 120 provide services to one or more customers. The system shown in FIG. 1 includes an exemplary customer named “John Doe.” The broker 102 comprises an information system (e.g., a computer with software) that includes a customer database 110. The customer database 110 includes storage for multiple customer records 112. Various items of customer information 114 are associated with each customer record 112. Such customer information 114 may include customer-identifying information such as name, address, and social security number that identifies the customer. Information 114 may also comprise other customer-specific information related to the services for which that customer has chosen from the service providers 120. For example, if one of the services is cellular telephone service, the customer information 114 may include that customer's particular rate plan.

In accordance with a preferred embodiment of the invention, each customer record 112 also includes one or more aliases 116. The aliases 116 preferably are generated or assigned by the broker when a customer signs up or otherwise associates himself or herself with the broker. As shown in FIG. 1, customer John Doe has been given four aliases (X349674, X87345, Y49265, and Y01834) by the broker system 102. Any number (one or more) of aliases is permissible for each customer. Each alias preferably comprises an identifier that can be used by the broker 102 to uniquely identify a particular customer. It is desirable for the alias to be such that it is exceedingly difficult, if not impossible, to determine which person is associated with the alias. In accordance with a preferred embodiment of the invention, each alias may comprise a seemingly random alphanumeric character string. The alias should be of a length comparable to actual names to help ensure compatibility with database formats in existing network equipment.

The customer database 110 in the broker system 102 preferably is the only site where both the customer-identifying information (e.g., name, social security number) and associated aliases are stored and thus only the broker system knows the actual identity of each customer. If other entities in the business system 100 need any information about a customer, a redacted copy of the broker's customer database 110 is downloaded or otherwise provided to that entity. For example, if the service providers 120 require information about customers to provide their services, the broker 102 provides a redacted customer database to each such service provider 120. The redacted customer databases are shown by reference numeral 122 in FIG. 1 and includes a plurality of customer records 124. The main difference between the redacted database 122 and the full customer database 110 is that the redacted database 122 preferably includes only an alias to identify each customer, not the customer's name. With only an alias, each service provider will not be able to identify the actual person. As such, the broker's customer list is effectively protected. The redacted customer database 122 may include whatever customer information 126 that service provider needs, such as rate plan for a cellular telephone customer, and does not include sensitive information and information that would permit the service provider to identify the customer. Alternatively, the redacted database 122 may includes some, but preferably not all, customer-identifying information with the aliases. For example, the database 122 may include names, but not social security numbers, of the customers. The aliases protect the information not provided to the service provider.

As shown in FIG. 1, each service provider 120 is provided a redacted customer database 122 with customer John Doe identified by a different alias in each database 122. That is, John Doe may receive services from each service provider and be recognized by each of his service providers by a different alias. If desired, however, each customer may only have one associated alias and be recognized by all service providers by the same alias. Using different aliases may advantageously increase the level of security provided in the business system 100.

Billing information from the service providers 120 specify the customer only by alias. Such billing information, therefore, preferably is sent back to the broker 102 which can then correlate the billing information back to the actual customers. The broker 102 can then provide a consolidated bill to the customer on behalf of all of the service providers 120. The broker may be paid by the service providers as a percentage of the billing revenue or as a monthly charge. Alternatively, the broker may be paid by a monthly fee by the customers themselves. Other billing schemes are also possible for the broker 102.

Further, each customer advantageously only interfaces with the broker, instead of with each service provider. The unified customer care interface provided by the broker permits the customer to not have to think about, remember, and/or manage multiple interfaces. This benefit is provided without comprising the customer's privacy.

An alternative embodiment is shown in FIG. 2. As shown, a business system 200 includes a vendor business system 202 and one or more network elements 220. The network elements 220 preferably provide services to customers. A difference between FIGS. 1 and 2 is that the system 100 in FIG. 1 generally contemplates the broker 102 and the service providers 120 being separately owned and controlled entities, whereas the system 200 in FIG. 200 contemplates the vendor business system 202 and network elements 220 being commonly owned. The exemplary embodiment in FIG. 2 illustrates that even for a business entity which both provides services and controls the customer relationship, security of customer information may still be a concern. For example, while the vendor business system 202 may be a secure computer system, one or more of the network elements 220 may not have sufficient security. Thus, it may behoove the vendor business system 202 to protect its customer information that it sends to each network element 220.

Accordingly, the vendor business system 202 includes a customer database 210 which has a plurality of customer records 212. In this embodiment, the vendor business system 202 effectively operates as the broker shown in FIG. 1. Each record 212 preferably includes the customer's name, customer information and an alias 216. More than one alias can be provided for each customer if desired. In the example of FIG. 2, John Doe only has one alias (X349674) and that alias is used by the network elements 220. As before, a redacted copy 222 of the customer database 210 is provided to each network element. The redacted copy 222 includes aliases, but preferably not customer-identifying information, although some customer-identifying information can be provided, if desired, as noted previously.

The preferred embodiments described above provide a convenient mechanism for customers to interact with multiple service providers using a broker as a “middle person”. The embodiments disclosed include a database in the broker's system that associates aliases with customers and it is only the aliases, not the names, which are provided to the service providers. As such, privacy is ensured and is easy to verify.

The preferred embodiment can advantageously be used to protect various items of a customer's financial information, such as credit card numbers, personal identification numbers, passwords, etc. To that end, the customer database 110, 210 may include such financial information, but such financial information preferably is not included in the redacted copies 122, 222. It should be apparent to one of ordinary skill in the art that the system described herein is also useful in the war against “identity theft.”

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A business system that permits a customer to receive services from a service provider through a broker, comprising:
a customer database associated with said broker, said customer database including customer records, each customer record including an alias associated with that customer and other information to identify the customer; and
a redacted copy of the customer database associated with said service provider, said redacted database including a record for each customer that includes the customer's alias and not information to otherwise identify the customer.

2. The business system of claim 1 wherein said alias comprises an alphanumeric character string.

3. The business system of claim 1 wherein said broker includes a computer system and said service provider includes a computer system and said redacted database is downloaded from the broker's computer system to the service provider's computer system.

4. The business system of claim 1 wherein said service provider provides billing information to said broker, said billing information includes customer aliases, and said broker uses said customer database to match the alias to the corresponding customer to provide a bill to a customer using the customer's name.

5. The business system of claim 1 further including a plurality of service providers.

6. The business system of claim 1 wherein each customer record includes a plurality of aliases for a customer.

7. The business system of claim 1 wherein said broker provides an interface to each customer on behalf of the service provider.

8. A business method, comprising:
(a) storing customer records in a customer database, each record including customer-identifying information;
(b) generating an alias for each customer;
(c) storing each said alias in the customer record of the corresponding customer; and
(d) providing a redacted version of the customer records to a service provider, the redacted version including aliases, but not the customer-identifying information.

9. The business method of claim 8, wherein (d) include providing a redacted version of the customer records to a plurality of service providers.

10. The business method of claim 8, wherein (b) includes generating an alphanumeric character string.

11. The business method of claim 8 wherein (b) includes generating a plurality of aliases for at least one customer.

12. The business method of claim 8 wherein (b) includes generating a plurality of aliases for each customer.

13. The business method of claim 8 further including receiving service provider information from each of said service providers for a particular customer identified by that customer's alias, matching the alias to the customer-identifying information, and providing consolidated service provider information to the customer.

14. The business method of claim 8 further providing a customer interface via a broker on behalf of multiple service providers.

15. A service broker system, comprising:
a computer system having a customer database, said customer database including customer records, each customer record including an alias associated with that customer and other information to identify the customer;
an interface to a customer; and
an interface to a service provider which provides services to said customer;
said computer system providing a reduced version of said customer database to said service provider, said reduced version not having said information to identify the customer, but includes the customer's alias.
